(19) United States
(12) Patent Application Publication
(10) Pub. No.: US 2017/0103172 A1
(43) Pub. Date: Apr. 13, 2017

(54) System And Method To Geospatially And Temporally Predict A Propagation Event

(71) Applicant: The Arizona Board of Regents on Behalf of the University of Arizona, Tucson, AZ (US)

(72) Inventors: Wolfgang Fink, Montrose, CA (US); Janet Meiling Roveda, Tucson, AZ (US)

(73) Assignee: The Arizona Board of Regents on Behalf of the University of Arizona, Tucson, AZ (US)

(21) Appl. No.: 15/289,110

(22) Filed: Oct. 7, 2016

Related U.S. Application Data
(60) Provisional application No. 62/238,673, filed on Oct. 7, 2015.

(51) Int. Cl. G06F 19/00; G06N 3/08

(52) U.S. Cl. CPC G06F 19/345; G06N 3/08; G06F 3/0484

(57) ABSTRACT

The present invention provides a system and method to geospatially and temporally predict a propagation event. The present invention for a plurality of predetermined locations, geospatially models the connections between each location. For each predetermined location, the invention temporally models the connections within each predetermined location. The present invention also pairs the geospatially modeling with the temporal modeling to generate a prediction of the spread of the propagation event.

### RELATED APPLICATIONS

This application claims the benefit of U.S. Provisional Application No. 62/238,673, filed Oct. 7, 2015 and herein incorporated by reference.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

With over 13,500 reported cases and 70% fatality rate (a big increase from the previously estimated 50%), the Ebola outbreak in West Africa has become one of the deadliest occurrences since its first discovery in 1976. Running away patients, notoriously poor villages, filthy and overcrowded slums in cities, and lack of effective control measures in the three Ebola outbreak countries Liberia, Sierra Leone, and Guinea are the leading causes of the rapid spread of the Ebola virus in the West Africa region.

According to the World Health Organization (WHO), without drastic improvements in control measures, the number of deaths from the Ebola virus is expected to reach thousands per week. Since the first Ebola death on Oct. 1, 2014 in the USA, the Ebola outbreak has become a global epidemic. By Nov. 1, 2014, the USA has identified 9 Ebola-infected cases and Europe reported 9 infected cases (Spain: 3, Germany: 3, Norway: 1, France: 1 and UK: 1). All the infected cases are travelers or healthcare givers that visited the three outbreak countries in West Africa.

How to quickly and effectively isolate and treat infected patients, and how to safely bury the dead ones in West Africa are the critical measures to stop this deadly epidemic. As pointed out by WHO experts, the success of the Ebola epidemic control relies on real time and accurate predictions of the spreading patterns of the Ebola virus, and on the understanding of the impact and effectiveness of isolation, countermeasures (e.g., road barriers, quarantines, etc.), investigational vaccinations, and other hospital treatments.

The last several years have also witnessed a couple of successful predictions for vector borne diseases such as Malaria and Chikungunya virus (CHIKV), viral zoonosis like Rift Valley Fever, and bacterial disease spreading by contaminated water and food such as Cholera. All the above mentioned diseases exhibit close links to climate variability and seasonality, especially tending to occur episodically after elevated temperatures and increased rainfall. As such, a number of environmental variables have been integrated into the prediction models. For example, sea surface height (SSH), sea surface temperature (SST), ocean chlorophyllconcentration (OCC), El Nino/Southern Oscillation (ENSO), normalized difference vegetation index (NDVI), outgoing long-wave radiation (OLR), land surface temperature (LST) have demonstrated close correlations to the above mentioned disease outbreaks in Africa and South Asia.

Using time-dependent climate and environmental variability, researchers have successfully predicted the incidence of Cholera in Zanzibar, East Africa by employing a multivariate autoregressive integrated moving average (ARIMA) model. The output of this predictive model was a monthly prediction of Cholera cases in one region of Unguja in Zanzibar.

No geospatial distribution or concentration information was included in this case. In fact, little has been done to provide dynamic, geospatial-temporal predictions for the risk of infection with virulence and transmissibility parameters. Not to mention that the existing prediction capability has only been validated for the above mentioned infectious diseases, which have, close links to climate and environmental variations. Emerging infectious diseases, especially Category A (such as Ebola, Anthrax, smallpox, etc.), may not be highly correlated to the environmental variability, and yet, these diseases are of highly unexpected nature: they may originate from remote areas such as Africa or south China, or are an immediate consequence of a biological weapon (i.e., Anthrax). Most of these pathogens are rarely seen in developed countries such as the USA, but they pose a risk to national security as these diseases can be easily transmitted from one person to another, causing high mortality rates, and leading to public panic and social instability. The emerging infectious diseases call for advanced prediction capacity and capability to allow decision makers to take timely and special action for troop/personnel deployment, public health preparedness, initiate control-and-response capabilities, and ultimately prevent or at least limit disease outbreaks.

In the past, ordinary differential equations (ODE) have been used to describe the dynamics of bacterial and viral infections. ODE approaches can be used to model the viral titer inside a person to model the intra-personal time-development of an infection. ODE approaches can also be used to model the spread of bacterial/viral diseases across a population or populations, such as the existing Susceptible-Infected-Recovered (SIR) and Susceptible-Exposed-Infected-Recovered SEIR models for the infection transmission dynamics. However, one of the major drawbacks of ODE-based approaches is the fact that they model only the temporal development of the overall concentration of infected subjects, healthy subjects, diseased subjects, pathogens, infected cells, and healthy cells, etc. They usually do not account for the spatial development of these diseases both inside a body and across a population, village, city, region, country, or countries, etc.

Several recent attempts have been made to use statistical ODE or stochastic ODE simulators to include potential spatial variation impact into infection prediction. Nevertheless, none of these approaches relate the spatial variations to the potential locations or interactions among different locations.

To account for deficiencies in ODE approaches, 2D or higher dimensional Cellular Automata may be used to add to the temporal component a spatial one. Doing so makes it possible to simulate over time the spatial behavior/clustering of infected cells versus healthy ones across a patch of tissue (e.g., lung tissue). Such cellular automata-based models can also be used to simulate on a macroscopic scale how a disease can spread across a village, city, region, country, or countries, etc.

In such cases each cell represents a village or city as opposed to individual cells. The dynamics of 2D Cellular Automata are characterized almost exclusively by nearest neighbor interactions, i.e., interactions with the 4 nearest or 8 nearest neighbors on a square lattice. Therefore, 2D Cellular Automata often lack far-ranging, non-local interactions. In different embodiments, longer range interactions can be implemented within 2D or higher dimensional Cellular Automata.

In both of the above cases, i.e., ODE- and 2D Cellular Automata-based approaches, there is an essential gap between the microscopic view—modeling the spread of a disease inside a human body or tissue—and the macroscopic view—modeling the spread of a disease across a population (inter-personal) or village, city, region, country, or countries, etc.

### BRIEF SUMMARY OF THE INVENTION

In one embodiment, the present invention provides innovative algorithms and models to forecast an event.

In a preferred embodiment, the present invention provides systems and methods that predict geospatially and temporally the spreading patterns of a propagation event.

In other embodiments, the present invention provides a disruptive viral/bacterial/fungal disease propagation model that allows for spatio-temporal simulations simultaneously on the macroscopic (village/city-level across a region, country, or countries, etc.) and the microscopic (intra-village/city person-to-person interaction) level. The model utilizes a combination of one or more 2D Cellular Automata for the macroscopic interactions, paired with the dynamics of Hopfield Attractor Artificial Neural Networks for the microscopic interactions. In use, the embodiment generates a reproduction number Rₒ and the effective reproduction number Rₜ, based on the Cellular Automata Hopfield simulations. These reproduction numbers not only indicate the threshold, e.g., of the Ebola outbreak (e.g., if Rₒ>1, then the number of infected cases will increase exponentially. If Rₒ<1, the few infected cases will recover to susceptible cases), but also reflect both spatial and temporal correlations and their impact on the reproduction numbers.

In other embodiments, the present invention integrates one or more 2D Cellular Automata with Hopfield Attractor Network Dynamics. In a specific embodiment, the present invention, as applied to a propagation event and/or spreading patterns such as those involving the spread of, e.g., Ebola, combines 2D Cellular Automata for the inter-village/city interactions on a macroscopic scale, paired with the dynamics of Hopfield Attractor Artificial Neural Networks (e.g., FIG. 1) for the intra-village/city interactions (i.e., person-to-person interaction within a respective village/city) on a microscopic scale. The advantage of using Hopfield attractor network dynamics lies in the fact that the constituting neurons of a Hopfield attractor neural net are fully connected to each other, i.e., N(N−1)/2 couplings or interaction pathways for symmetric interactions (i.e., interaction between neuron A to B is the same as interaction between neuron B to A) (FIG. 1), or N(N−1) couplings for asymmetric interactions (i.e., interaction between neuron A to B is different from interaction between neuron B to A), or N² couplings for asymmetric interactions including self-interactions (i.e., neuron A interacts with itself in addition).

Self-couplings/interactions in the context of infectious diseases can make sense as a person may self-infect (e.g., through drug abuse-related needle sharing, or burial traditions such as washing rituals of the diseased). However, self-couplings/interactions are not assumed in the following. Also, it is reasonable to assume symmetric interactions/couplings: person A interacts with person B the same way person B interacts with person A from an infection point of view (however, different interactions schemes may apply as well, resulting in asymmetric interactions/couplings). Moreover, since people in a village or city are likely to interact with people across the village or city, one should allow for non-local interactions, i.e., interactions beyond nearest neighbors. Hence, taken all of the above into account, one arrives at the standard model of a Hopfield attractor network with N neurons (i.e., people per village/city, etc.) that are connected to each other via N(N−1)/2 couplings or interaction pathways for non-local symmetric interactions (i.e., interactions of all village- or city-inhabitants).

In yet other embodiments, the present invention combines a geospatial model based on a cellular automaton and an ODE driven model with the integration of a neural network model to provide temporal development on a spatial, highly granular level. The granular level represent differing regions that may be affected over time for by a propagation event. Differeing levels of granularity may be represented by a country, state, county and city, etc. . . . .

The model may incorporate in a preferred embodiment people's behavior patterns, special events (e.g., festivals, gatherings, rituals, etc.) and measures (e.g., countermeasures, such as road barriers), and other environmental factors (e.g., weather, road conditions, etc.) as the data information to allow for spatio-temporal predictions simultaneously on the macroscopic (inter-village/inter-city, inter-region, or inter-country, etc.) and the microscopic (intra-village/city person-to-person) level. That is, it can predict incidences at a predetermined level, such as at the village level, as well as how predetermined units, such as villages, would interact with one another in a specific region as a result of the predictions at both microscopic and macroscopic levels.

Summing up all the number of incidences from the prediction model may generate predictions that may be displayed as color-coded probability maps, akin to weather forecast maps, to highlight regions with predicted high incidence occurrences together with time-lapsed information.

In yet other embodiments, the present invention provides a spatio-temporal viral/bacterial/fungal disease propagation model that integrates microscopic and macroscopic propagation modalities, allowing for enhanced prediction of disease propagation over time.

In other embodiments, the present invention provides a basic reproduction number Rₒ and effective reproduction number Rₜ to predict the spread of the propagation, such as Ebola disease transmission, over time both within a region and among regions.

In further embodiments, the present invention provides a sensitivity analysis framework to enable the evaluation of control measures (e.g., quarantine, road barriers, etc.) and to provide estimations of their impact on the propagation event, such as Ebola transmission dynamics.

In yet further embodiments, the present invention determines the amount of time required to reach local asymptotic stability (for each region), the amount of time needed to achieve global asymptotic stability, e.g., for Ebola transmission dynamics, as well as the disease-free equilibrium, to establish a set of metrics to understand the effectiveness of control measures.

In still further embodiments, the present invention pairs 2D Cellular Automata for the macroscopic interactions, with the dynamics of Hopfield Attractor Artificial Neural Networks for the microscopic interactions.

In other embodiments, the output of the invention includes a colored map with supporting displays, pie-charts, curves, diagrams and text messages at different levels of granularity to provide detailed warnings and alerts with a predicted number of new infectious disease cases at upcoming weeks and months. Given trends of a certain disease appearing with greater or lesser intensity, and a background data collection or historical records in a region/country, the present invention can identify unusually high incidence of a particular disease and indicate where and when its normal outbreak will happen. The outcomes may provide decision makers with the ability to identify and estimate the risk of a particular disease for troop or personnel deployment in a region at a granularity level down to predetermined regions, such as zip-codes for example.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

In yet another embodiment, the present invention provides a method to geospatially and temporally predict a propagation event comprising the steps of: (a) for a plurality of predetermined locations, geospatially modeling the connections between each location; (b) for each predetermined location, temporally modeling the connections within each predetermined location; and (c) pairing the geospatially modeling with the temporal modeling to generate a prediction of the spread of the propagation event.

In yet another embodiment, the present invention provides a method comprising the step of pairing 2D Cellular Automaton with Hopfield Attractor Network Dynamics.

In yet another embodiment, the present invention provides a method comprising the step of pairing the 2D Cellular Automata for interactions on a macroscopic scale such as inter-village and/or city, with the dynamics of Hopfield Attractor Artificial Neural Networks for interactions on a microscopic scale such as intra-village and/or city.

In yet another embodiment, the present invention provides a method comprising the step of generating output that includes a colored map with supporting displays such as pie-charts, curves, diagrams and/or text messages at different levels of granularity which may include, but are not limited to, preparing zones or areas in which the propagation event expands, to provide detailed warnings and alerts with predicted number of the growth spread. In other embodiments, the predetermined locations are zip-codes.

In yet other embodiments, the methods include Hopfield attractor networks with N neurons that are connected to each other via N(N−1)/2 couplings or interaction pathways for non-local interactions. In still further embodiments, the present invention includes methods having Hopfield attractor networks wherein the neural coupling strength is inversely proportional to the number of inhabitants of a predetermined location expressed as proximity factors that may reflect gathering behaviors specific to the predetermined location. In yet other embodiments, the present invention provides a method wherein the 2D Cellular Automaton interactions have varying weights. In still further embodiments, the varying weights of the interactions are based on conditions between the nearest neighbors or road mobility models and/or the varying weights of the interactions are based on distance and/or street conditions.

In addition, the embodiments of the present invention may further include the step of using a Stochastic Optimization Framework (SOF) that samples model-intrinsic parameter space by repeatedly running the respective model forward and by comparing the outcomes against the desired outcome, which results in a fitness measure. The embodiments of the present invention may also include the step of extrapolating time-wise the behavior of the SOF-obtained cellular automaton Hopfield attractor network that is specific to both a region and a particular propagation event to yield probability maps of growth spread and spread prediction for a particular region.

In yet other aspects, the embodiments of the present invention further comprise the step of using polynomial chaos series to predict the number of incidences for a future time period.

In other aspects, the embodiments of the present invention include providing a map of a predetermined region. Additional features may also include the step of providing a map of a predetermined region wherein at each level, different operations are shown. Still further features include providing a map of a predetermined region wherein basic operations used include “Zoom In”, “Zoom Out”, “New Node” (for cities/villages/regions), and parameter inputs from historical data through file upload.

In yet other aspects, the embodiments of the present invention further include providing a map of a predetermined region wherein there is “weight” for the edges and “concentration” for the changes of node values to reflect condition changes. Still further features include providing a map of a predetermined region wherein a user is allowed to focus on one or more locations of interest by selecting a predetermined area or region which are displayed on one or more colored maps for outbreak predictions or forecasts in temporal and geospatial forms. Yet further features include providing a map of a predetermined region wherein the edges connecting nodes represent roads and different thickness of edges denote variations in the road throughputs or road mobility models and/or providing a map of a predetermined region wherein the thicker the edge, the higher throughput of the road.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 illustrates a fully-connected Hopfield attractor network. All neurons, denoted as circles, are fully connected to each other by symmetric neural couplings depicted as black lines. Self-couplings are not shown.

FIG. 2 illustrates a proposed spatio-temporal viral/bacterial/fungal disease propagation model, using a combination of 2D Cellular Automaton for macroscopic interactions 10-20 which may be inter-village/city interactions of varying interaction strengths, paired with the dynamics of Hopfield Attractor Artificial Neural Networks 30-37 for the microscopic interactions within villages/cities 40-47.

FIG. 3 is a functional schematic of a Stochastic Optimization Framework (SOF): The SOF efficiently samples the entire model/process/system-intrinsic parameter space by repeatedly running the respective model/process/system forward (e.g., on a single, cluster, or parallel computer) and by comparing the outcomes against a desired outcome, which results in a fitness measure. The goal of the SOF is to optimize a fitness by using multivariate optimization algorithms as the optimization engine.

FIG. 4 displays the prediction results using an embodiment of the present invention in the center location in the city of Freetown, Sierra Leone.

FIG. 5 displays the prediction results for Bambali, Sierra Leone using an embodiment of the present invention.

FIG. 6 illustrates how an embodiment of the present invention may be configured to provide decision-makers with geo-spatial and temporal information at the country-level.

FIGS. 7 and 8 illustrates how an embodiment of the present invention may be configured to provide decision-makers with geo-spatial and temporal information at various regions, such as, cities, villages, and zip-code regions.

FIG. 9 illustrates an existing SEIR model (left) and a spatial disease propagation model provided by an embodiment of the present invention (right).

FIG. 10 demonstrates the anticipated results of the proposed new framework using an embodiment of the present invention.

FIG. 11 illustrates example strengths of interactions among different locations based on throughput rate estimation for an embodiment of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

In a preferred embodiment, the present invention may be used to forecast, predict, map, or otherwise determine and analyze propagation events and/or spreading patterns. Propagation events may include, but are not limited to, troop movements, mobs, insect swarms, vector related events such as diseases and viral outbreaks, the deployment of human assets, such as military and civilian, including mobile and immobile assets, troop deployments, weather and climate events, air and vehicle travel, mobility events, vessel and water traffic (e.g., ships), vehicle and air traffic, general transportation events, logistics, the distribution of products from raw materials to consumer goods delivered at the retail or home level, floods, storms, rain, precipitation, draught, nuclear fallout, biological events both natural and manmade, viral such as the Zika virus social groupings, behavioral patterns, war games, nuclear warfare, biological warfare, chemical warfare, emergency evacuations, crop production and protection, fire, floods, oil and gas, as well as forest fires and game chaos (e.g., rioting).

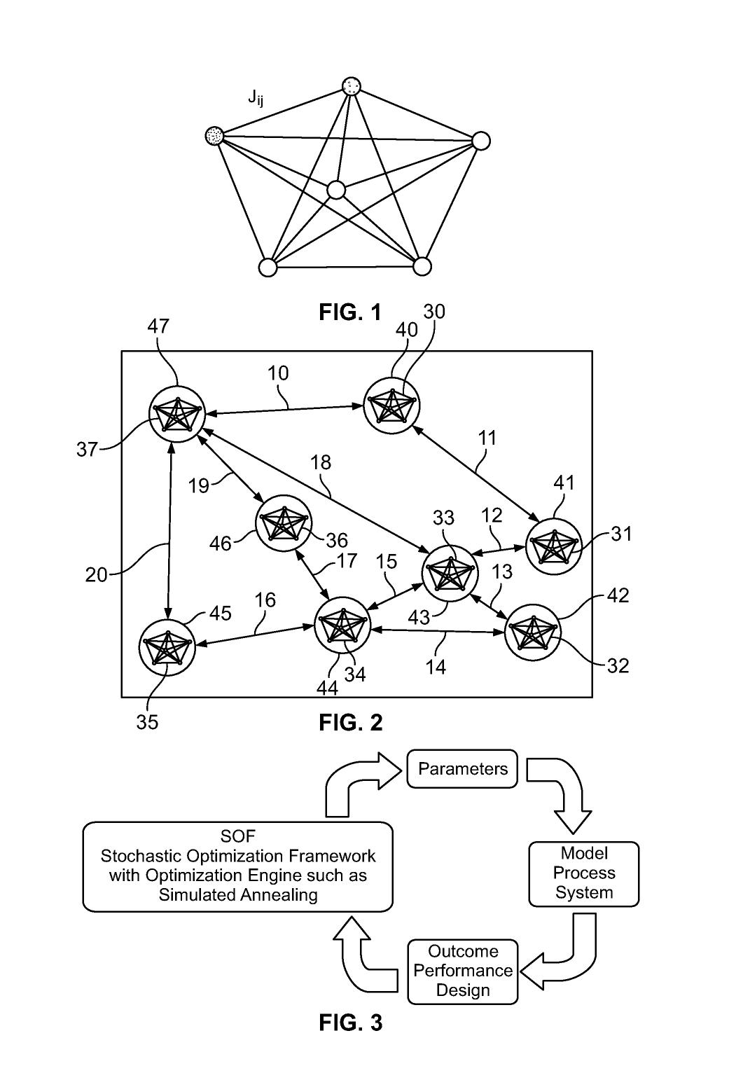

In one exemplary embodiment of the present invention, the method and system will be described herein and applied to the propagation event involving the spread of Ebola. In this embodiment, one or more 2D Cellular Automata for the location of origin for the propagation event such as an inter-village/city interactions on a macroscopic scale are paired with the dynamics of Hopfield Attractor Artificial Neural Networks (FIG. 1) for the intra-village/city interactions (i.e., person-to-person interaction within a respective village/city) on a microscopic scale. The advantage of using Hopfield attractor network dynamics lies in the fact that the constituting neurons of a Hopfield attractor neural net are fully connected to each other, i.e., N(N−1)/2 couplings or interaction pathways as shown in FIG. 1.

Self-couplings/interactions in the context of infectious diseases can make sense as a person may self-infect (e.g., through drug abuse-related needle sharing, or burial traditions such as washing rituals of the diseased). However, self-couplings/interactions are not assumed in the following. Also, it is reasonable to assume symmetric interactions/couplings: person A interacts with person B the same way person B interacts with person A from an infection point of view (however, different interactions schemes may apply as well, resulting in asymmetric interactions/couplings). Moreover, since people in a village or city are likely to interact with people across the village or city, one should allow for non-local interactions, i.e., interactions beyond nearest neighbors. Hence, taking all of the above into account, one arrives at the standard model of a Hopfield attractor network with N neurons (i.e., people per village/city) that are connected to each other via N(N−1)/2 symmetric couplings or interaction pathways for non-local interactions (i.e., interactions of all village- or city-inhabitants).

Artificial neural networks (ANN), such as multi-layered feed forward networks (e.g., multi-layered perceptrons), multi-layered recurrent networks, and fully connected attractor networks (e.g., Hopfield attractor networks), are at the core of Artificial Intelligence (AI) and Cognizant Computing Systems. ANNs are powerful methods, most prominently used for: the classification and analysis of multi-dimensional data; the learning of rules underlying data (i.e., so-called “generalization”); and the control of, e.g., dynamic, highly non-linear systems.

In general terms, ANNs consist of mathematical/computational neurons (e.g., McCulloch-Pitts neurons) that are binary or real-valued entities combined with step-like (e.g., sign- or signum function) or sigmoidal transfer functions (e.g., tan h(x)) to imitate the action potentials in biological neurons. In the case of attractor networks, such as Hopfield attractor networks (e.g., FIG. 1), the neurons are fully interconnected as a non-layered ensemble, acting both as input and output neurons that undergo a dynamic iteration process to update their individual states (so-called relaxation process):

Vᵢ(t+1)=sgn(ΣⱼJᵢⱼVⱼ(t)−θ) (1)

with Jᵢⱼ=neural coupling between neuron land neuron j, Vⱼ(t)=state of neuron j at time t, θ=threshold (often set to 0 as is the case here), and sgn(x)=sign- or signum function with, e.g., the following definition: sgn(x)=+1 for x>0, 0 for x=0, and −1 for x<0. Other definitions of sgn(x) are possible. A steady state or attractor of the network dynamics is reached when the following condition holds true: Vᵢ(t+1)=Vᵢ(t) for all i=1, . . . , N neurons.

In an embodiment using a first modeling approach, the present invention identifies an individual subject which in this case is a healthy (uninfected) person with a neural state of “−1” and another individual subject which in this case is an infected person with “+1”, which corresponds to the standard approach for Hopfield neural networks using the signum function as a neural transfer function to convert local neural fields into a firing or non-firing neural state of the neuron under consideration. A diseased person is assigned the respective neuron value “0”. Since the neural state of time step t plays a role in determining the neural states of all neurons at time step t+1, this will naturally lead to no interaction contribution coming from this kind of neuron, i.e., diseased person. Note, that this would not take into account infections stemming from burying diseased people. These types of infections could be modeled via self-couplings, i.e., a person burying diseased people may infect themselves. Neural coupling strengths are usually fixed in Hopfield attractor networks.

In this embodiment, the neural coupling strength could be inversely proportional to the number of subjects to be monitored such as inhabitants of a village or city, i.e., the more inhabitants there are, the lesser the chances of interacting with all of them. Conversely, the coupling strengths may be expressed as proximity factors that may reflect gathering behaviors specific to villages, cities, or regions.

Moreover, by subjecting fixed couplings or interactions to probabilities for executing a particular interaction between two neurons (i.e., subjects/people) during the relaxation process underlying Hopfield attractor networks, the present invention may infuse a probabilistic component to the network dynamic to tie the propagation event/infection rate to real interactions. Moreover, coupling strengths may be subject to change over time, e.g., to reflect changes in behavior due to awareness, panic, or quarantines, etc. Usually Hopfield attractor networks are used as associative memories, i.e., they classify noisy representations of pristine patterns stored as attractors of the network dynamic. Thus, convergence to a fixed state (i.e., attractor) is usually the goal. In the case of infections though, it is not necessarily expected for the network to converge. The Hopfield networks will continue to update the neural states in each village/city as shown in FIG. 2.

On the other hand, the 2D Cellular Automata framework will account for the inter-village/city transfer of diseases as illustrated in FIG. 2. Here, interactions of all villages/cities with all other villages/cities in a region or country may make no sense.

Rather, infection propagation via inter-village/city transfers can be modeled by randomly infecting an inhabitant in the target village/city, e.g., according to a probability inverse proportional to the Euclidian distance between two villages (FIG. 2). It should also be pointed out that in the particular case of Ebola the incubation time and time to death in approximately 70% of all cases happen on a much shorter time scale than natural birth and death rates. As such, in a first approximation, the present invention will not take into account birth and natural occurring death in a population, i.e., the initial “neuron” numbers in the Hopfield attractor network governing each village will be considered a constant. Of course, in other embodiments, replenishing of neurons (natural birth) can be easily implemented if need be. Natural death could be right away implemented by simply setting the state of a neuron to “0” independent of viral infection after a certain time has elapsed.

The embodiments of the present invention have been adapted to interface to real world scenarios. For example, the spatial components on the cellular automaton level can be influenced by external factors including Euclidian distance/distance between villages/regions/cities, road conditions, road mobility, weather, inter-city connectivity, transportation infrastructure such as cars, trains, air traffic, just to name a few. These external factors create the stage or the spatial fixed stage for the cellular automaton. This allows for modeling of the propagation event pathway, e.g., road blocks for quarantine purposes by simply cutting a connection in the underlying 2D cellular automaton from one village to another, or due to weather, e.g., flood. As such, the inter-village/city transfer of diseases (via inter-node connections) may be subject to change on a temporal as well as on a spatial level.

The Hopfield neural network component models the intra-village inhabitants of certain regions. The model is general enough to adapt to typical behaviors of certain locations of propagation events, such as regions of the geographic area. For example, there may be displacement due to food and water shortages caused by infectious disease, and medical treatments. In this scenario, the structure of the cellular automaton stays the same as it models the fixed rigid structures of where cities and villages are. The changing factor is the concentration of people or the number of inhabitants (inside the nodes of FIG. 2). A dynamically interacting and changing neural network architecture can accommodate this change.

In a preferred embodiment, certain regions of high incidences or high death rate may be thinned out overtime. Therefore, in the corresponding neural network model, the interactions among neurons become sparse by removing nodes/neurons and/or couplings within the respective neural network. As a result, it is expected to see the migration and growing of neural networks (i.e., adding nodes/neurons and/or couplings to the respective neural network) in regions equipped with better health care and supplies.

In another embodiment, nodes may be added to a 2D Cellular Automaton, e.g., when a healthcare providing camp is built in a previously uninhabited area. Conversely, nodes may be removed from a 2D Cellular Automaton, e.g., if a village is abandoned or wiped out due to disease.

In yet another embodiment, while the microscopic (intra-village/city person-to-person interaction) structure is simulated by a Hopfield attractor network, the macroscopic (village/city-level across a region, country, or countries, etc.) structure can also be simulated by a Hopfield attractor network, wherein each neuron acts as a super-neuron, representing an entire village/city, region, country, or countries, and the neural couplings are the couplings between the super-neurons representing the links (e.g., roads) between these nodes.

In again another embodiment, while the macroscopic (village/city-level across a region, country, or countries, etc.) is simulated by one or more 2D or higher dimensional Cellular Automata, the microscopic (intra-village/city person-to-person interaction) structure can also be simulated by one or more 2D or higher dimensional Cellular Automata, wherein the links represent the interactions amongst the constitutents (e.g., intra-village/city person-to-person interaction).

An optimization process may also be used to fit the model parameters to the observed evidence in terms of temporal and geospatial changes. To accomplish this multi-dimensional optimization, a Stochastic Optimization Framework (FIG. 3) may be employed.

Parameter-driven mathematical and physical models may describe many systems and processes, both natural and artificial. These models are usually exercised in a forward-fashion: A certain set of values for the model-intrinsic parameters yields a corresponding outcome when processed through the model at hand. It is usually a straightforward task to define what an optimal outcome of the model is. Conversely, it is incomparably more difficult, if not impossible in many cases, to determine what the corresponding parameter values are that, when applied to the model, yield this outcome, or approximate it as closely as possible. In addition, if more than one set of parameter values yields the same desired outcome, the model is degenerate. One way to determine the optimal parameter values is to analytically invert the models, or to run them backwards. In many cases this is analytically or practically infeasible or impossible due to the model-related complexity and high degree of non-linearity. To overcome this inherent problem, an embodiment of the present invention uses a generally applicable Stochastic Optimization Framework (SOF) that can be interfaced to or wrapped around such models to effectively “invert” them.

A Stochastic Optimization Framework (SOF, FIG. 3) allows for efficient sampling of the entire model-intrinsic parameter space by repeatedly running the respective model forward (e.g., on a single, cluster, or parallel computer) and by comparing the outcomes against the desired outcome, which results in a fitness measure. The goal of the SOF is to optimize this fitness. This approach is in sharp contrast to optimizing around a point design, which is often the case in engineering. Deterministic optimization techniques, such as gradient-based steepest-descent methods, are powerful and efficient in problems that exhibit only few local minima in the solution space. However, when dealing with multiple or infinite numbers of local minima, heuristic stochastic optimization methods, such as Simulated Annealing and related algorithms, such as Genetic Algorithms, and other Evolutionary Algorithms, may become the prime methods of choice because of their capability to overcome local minima.

To match/replicate historical data, or up-to-date data as they unfold, the present invention uses a SOF to fit the couplings Jᵢⱼ in the Hopfield attractor network for each village/city node, as well as the inter-node couplings Tᵢⱼ of the underlying 2D cellular automaton, such that an ab-initio temporal simulation produces as closely as possible the historical/up-to-date trajectory of disease development. The initial fitting discrepancies will constitute the various “fitness” levels of the solutions that are to be optimized (e.g., minimized) via SOF as outlined above.

In yet another embodiment, if after many optimization runs, sets of similar model parameters that govern the model to replicate given situations are reached, it may be concluded that a good understanding of how the infectious disease spreads in a region has been obtained. On the other hand, it is also possible that sets of significantly different model parameters were generated when explaining the same changes or people behaviors in given situations. Under this situation, the original model is not sufficiently defined enough, i.e., it is degenerate: additional, e.g., orthogonal, parameters need to be included into the original model to get rid of this degeneracy. Implications of degeneracy in the model will include also existing ambiguity. The model takes in historical data that includes both temporal and spatial information. For example, the model may be fitted to the first infected incidence and road conditions, i.e., road blockages as part of quarantine measures by cutting the corresponding connections of the neural network model.

Once a reasonable data fit is obtained via SOF as outlined above, the prediction capability is achieved by extrapolating time-wise the behavior of the SOF-obtained cellular automaton Hopfield attractor network setup that is specific to both a region and a particular disease. This will yield probability maps of disease outbreak and spread prediction or forecast in a particular region to assist decision makers prior to troop/personnel deployment. The time extrapolation can span various time intervals/periods, such as, e.g., days, weeks, months. Shorter or longer time periods can be extrapolated as well.

Other embodiments provide a collocation method that is based on polynomial chaos series. This works when there are sufficient numbers of examples of meaningful historical data with possible changes of interactions captured by the cellular automaton Hopfield attractor network method. Autoregression may be performed and moving average techniques using several samples of historical data for the number of incidences“. Let Y(x,y,t) represent the trend function that captures the changes of the number of incidences” for the future based on historical data. Y(x,y,t) may be modeled as a sum of polynomial chaos series w.r.t. x, y, and t:

$$Y ( x , y , t ) = {\sum }_{i = 0}^{N} {a}_{i} {φ}_{i} ( x , y , t ) \qquad ( 2 )$$

Here, aᵢ is the coefficient for polynomial φᵢ, which is part of a set of known polynomial chaos series. For example, Hermite, Legendre, Laguerre, and other orthogonal polynomials can be used. The decision of which polynomials to use depends on the results of the cellular automaton Hopfield attractor network method, which models changes of interactions among different locations. The SOF will lead to coefficients aᵢ, with minimum estimation error using Equation (2). Once the trend function model is obtained as in Equation (2), the trend function is combined with the results of autoregression and moving average approaches (i.e., by using multiplication) to predict the number of incidences for a future time period.

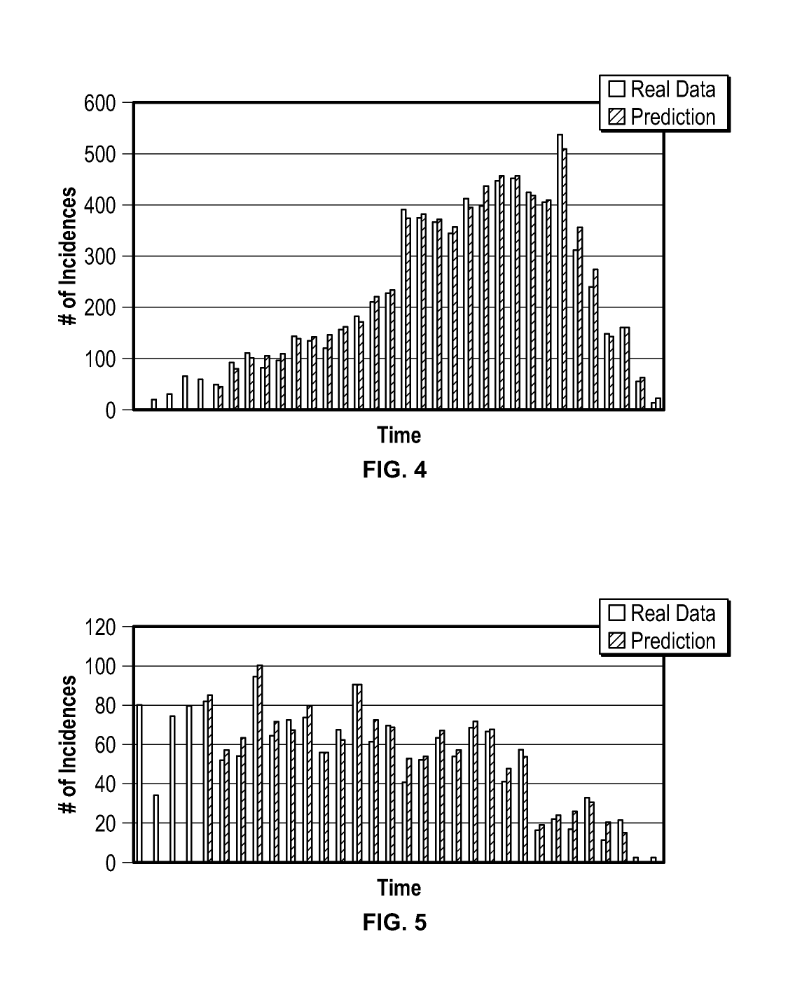

FIG. 4 displays the prediction results using an embodiment of the present invention in the center location in the city of Freetown, Sierra Leone. The non-hashed bars represent the number of incidences that actually happened during a thirty-two-week period of time. The hashed bars represent the predicted results based on existing historical data. The average prediction error is 7.5%. The prediction was started after four weeks of historical data. FIG. 5 displays the prediction results for Bambali, Sierra Leone. As may be observed from the data, the number of incidences changes very differently compared to the ones from Freetown. The average prediction error is 14.6%.

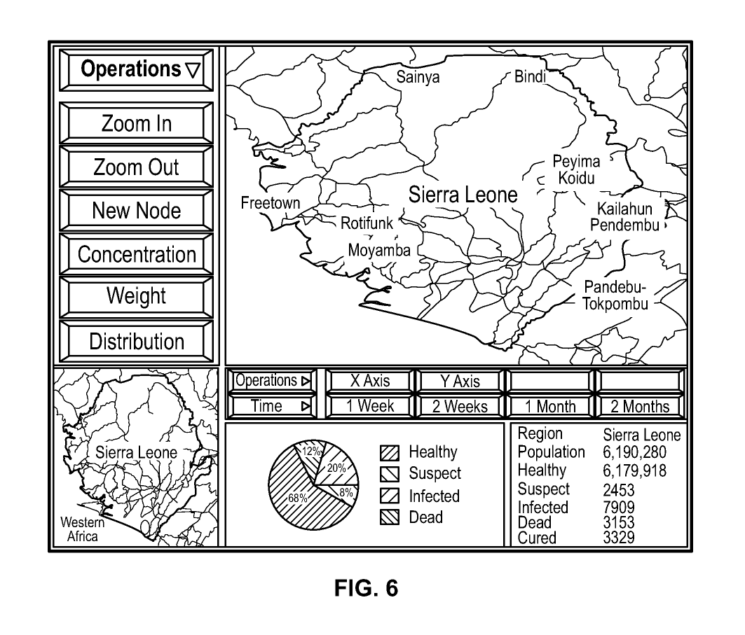

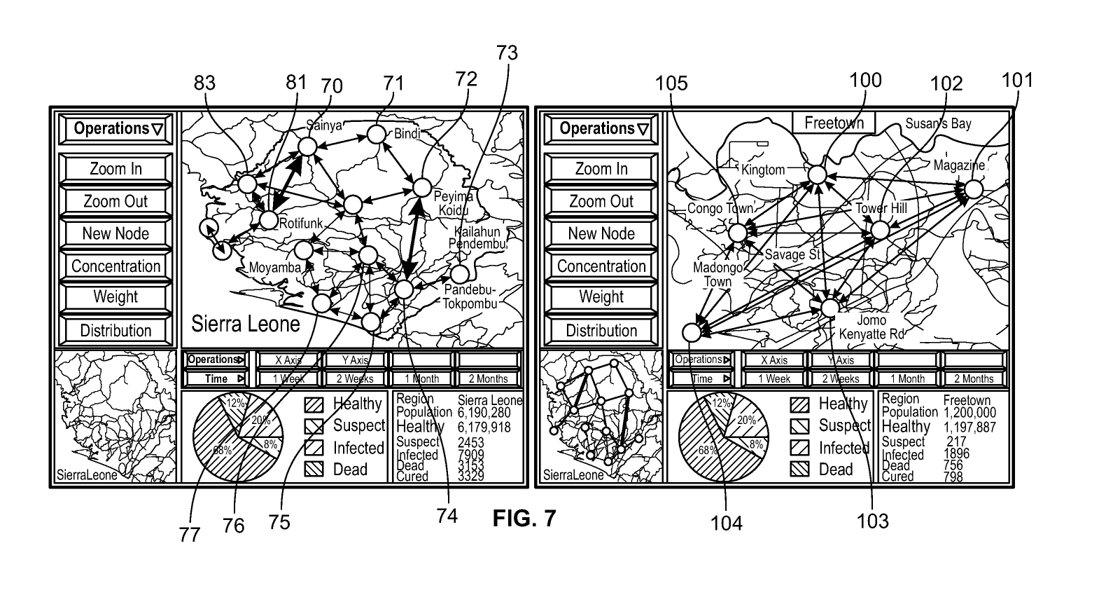

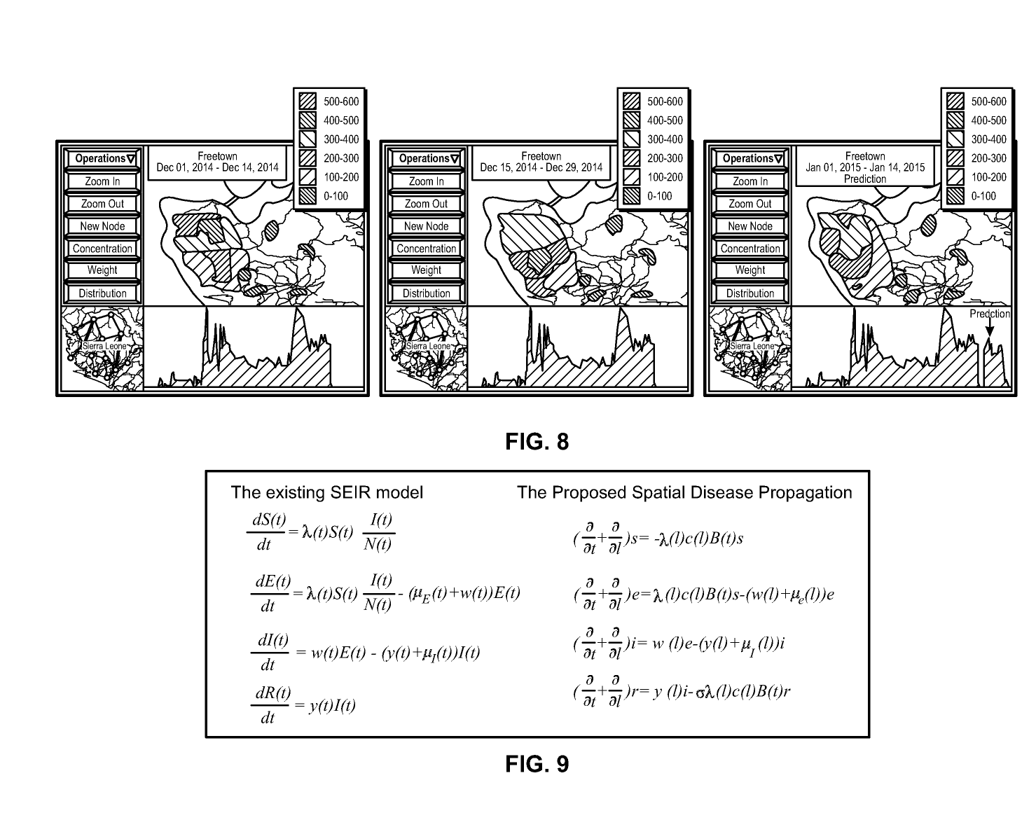

In yet other embodiments, the present invention provides a tool that provides decision-makers with geo-spatial and temporal information at various granularity levels, ranging from a country-level (FIG. 6) down to regions, cities, villages, and zip-code regions (FIGS. 7 and 8). Example output data comprise: prediction maps which may be colored for number of incidences at user-selected granularity levels and regions of interest (FIG. 8); Pie-charts for different population categories (healthy, suspects, infected, dead; FIGS. 6 and 7, bottom); Cellular automaton connectivity display for a region of interest (FIG. 7, left); Hopfield Attractor Network dynamic display for a region of interest (FIG. 7, right); and Incidence-time curve display for past, present, future for a user-selected region of interest (FIG. 8).

FIG. 6 demonstrates the screenshot of an embodiment of the present invention that provides a prediction tool. At each level, different operations are shown. For example, to perform cellular automaton simulations, basic operations that may be used include “Zoom In”, “Zoom Out”, “New Node” (for cities/villages/regions), and parameter inputs from historical data through file upload. The direct inputs from the graphic user interface (GUI) are designed for what-if scenario simulations.

For example, there is “Weight” for the edges and “Concentration” for the changes of node values to reflect condition changes. For instance, a map for a region of interest such as the western African region may be uploaded. The “Zoom In” feature allows a user to focus on a location of interest such as a country of interest, e.g., “Sierra Leone.” By selecting the major villages, cities, and regions, one or more colored maps for outbreak predictions in temporal and geospatial forms may be provided. Sierra Leone is shown as an example.

FIG. 7 shows the generated Cellular Automaton to model fourteen town/cities in Sierra Leone. Each node 70-83 represents one town or city. The edges (arrows) connecting nodes (inter-node connections) represent propagation pathways. Propagation paths may include any pathway in which a propagation event or spreading pattern to be monitored may progress, travel or be plotted. Different thickness of edges denotes variations in the throughputs: the thicker the edge, the higher the throughput (e.g., traffic volume).

Zooming in on one city, e.g. “Freetown”, the created Hopfield Neural Network Component model for zip code regions 100-105 inside the city of Freetown may be seen. In addition, as discussed above, the edges (arrows) connecting nodes 100-105 represent propagation paths such as roads.

FIG. 8 demonstrates a map of the Ebola outbreak from Dec. 1, 2014, to Jan. 14, 2015. As shown, incidences vs. time for a selected region or geographic area, such as Freetown, may be displayed.

In other embodiments, at any point in time during the simulation of a propagation event and/or spreading pattern, the respective numbers of uninfected, infected, and diseased people per village/city and overall for a region or country can be calculated. As such, the present invention provides a model that is able to produce the respective system trajectories (i.e., forecast concentrations of an event) over time, which can serve as ground-truth data for ODE-based transmission dynamic models to be fitted against to obtain essential parameters such as the basic reproduction number Rₒ and the effective reproduction number Rₜ. For the Ebola propagation event discussed in the exemplary embodiment, Rₒ represents the number of infected cases one infected case can generate on average over the course of its infectious period. This metric is useful because it helps determine whether or not an infectious disease can spread through a population. In many real cases, it is important to reveal the time-dependent and spatial-dependent variations in the transmission of the propagation event such as an infectious disease, which can be achieved by developing the effective reproduction number Rₜ.

The Ebola transmission can be modeled as Susceptible-Exposed-Infectious-Recovered (SEIR) dynamics using a set of ODEs. Let variables S, E, I and R represent the number of persons that are susceptible, exposed, infected and recovered, respectively. These variables are both time (t) and location (l) dependent. Thus, a transmission dynamic system can be modeled as in FIG. 9 (left) where λ is the susceptible exposure rate, w is the infection rate, μ_{E}, and μ_{I}, are death rates at exposed and infected stages, y is the recovery rate, σ is the per capita infection rate, B is the probability of getting infected when in contact with infected subjects, and cis the per capita contact rate.

This approach models the transmission dynamics as time dependent (or temporal dependent). The effective reproduction Rₜ number is calculated as the ratio of the infection rate over the summation of recovery rate and the death rate at infected stages. Thus, there is:

$${R}_{t} = \frac{w ( t )}{γ ( t ) + {μ}_{t} ( t )} \qquad ( 3 )$$

which is time dependent. The average of Rₜ over a period of time, e.g., T becomes Rₒ.

The above approach neglects the fact that the Ebola epidemic is in three West African countries. It is therefore important to find out the spatial spreading patterns in the region. Let s(l,t), e(l,t), i(l,t) and r(l,t) be the density functions of the number of susceptible, exposed, infected and recovered cases. Here l denotes locations and t denotes time changes. The density functions or the values of density functions can be extracted from the cellular automata method, and the relationships between the number of susceptible, exposed, infected and recovered cases and each density function can be expressed as:

S(t)=∫_{lεΩ}_{_{L}}s(l,t)dl, E(t)=∫_{lεΩ}_{_{L}}e(l,t)dl, l(t)=∫_{lεΩ}_{_{L}}i(l,t)dl (4)

and

R(t)=∫_{lεΩ}_{_{L}}r(l,t)dl. (5)

Here Ω_{L} is a set of the locations. Using the density functions of the number of susceptible, exposed, infected and recovered cases leads to a set of partial differential equations that can incorporate both spatial and temporal variations in the transmission dynamic model for propagation events, such as Ebola (refer to FIG. 9, right). Most coefficients in the above equations have the same meaning as in the SEIR model except now they are also spatially dependent in addition to time-dependency. In addition, c(l) is the spatial specific contact rate. σ is now the reduced risk factor (e.g., due to quarantine procedures). The model also provides a framework for sensitivity analysis. This is an important step to understand the time to local asymptotic stability (e.g., for a limited period of time, there is no more increase in the number of death cases caused by Ebola) and to global asymptotic stability (e.g., for infinite amount of time, no more changes in the number of cases is observed), as well as to identify the disease-free equilibrium (e.g., the population under monitoring has not been infected by diseases such as Ebola) of the transmission dynamic system. The effective reproduction number Rₜ based on the model can be generated. For example, let p(t,lᵢ,lⱼ) be the probability of a village at location lᵢ to have a contact with another village at location lⱼ at time t. It may be assumed that that there is proportionate mixing so the spatial and temporal functions can be modeled as the product of a spatial function and a temporal function. With these assumptions, the effective reproduction number Rₜ can be analytically derived as:

$${R}_{t} = {\int }_{{Ω}_{L}^{*}}^{ } {\int }_{{t}_{i}}^{{t}_{j}} p ( τ , l ) λ ( l ) c ( l ) \frac{w}{γ} ( {e}^{- w τ} - {e}^{- γτ} ) d τ d l \qquad ( 6 )$$

Here Ω_{*L} is a subset of points of original location from which a propagation event begins such as villages or other locations. Ω_{*L} [symbol] Ω_{L}. Therefore, Rₜ, the effective reproduction number of the propagation event, is both time (e.g., tᵢ to tⱼ) and location dependent (e.g., Ω_{*L}).

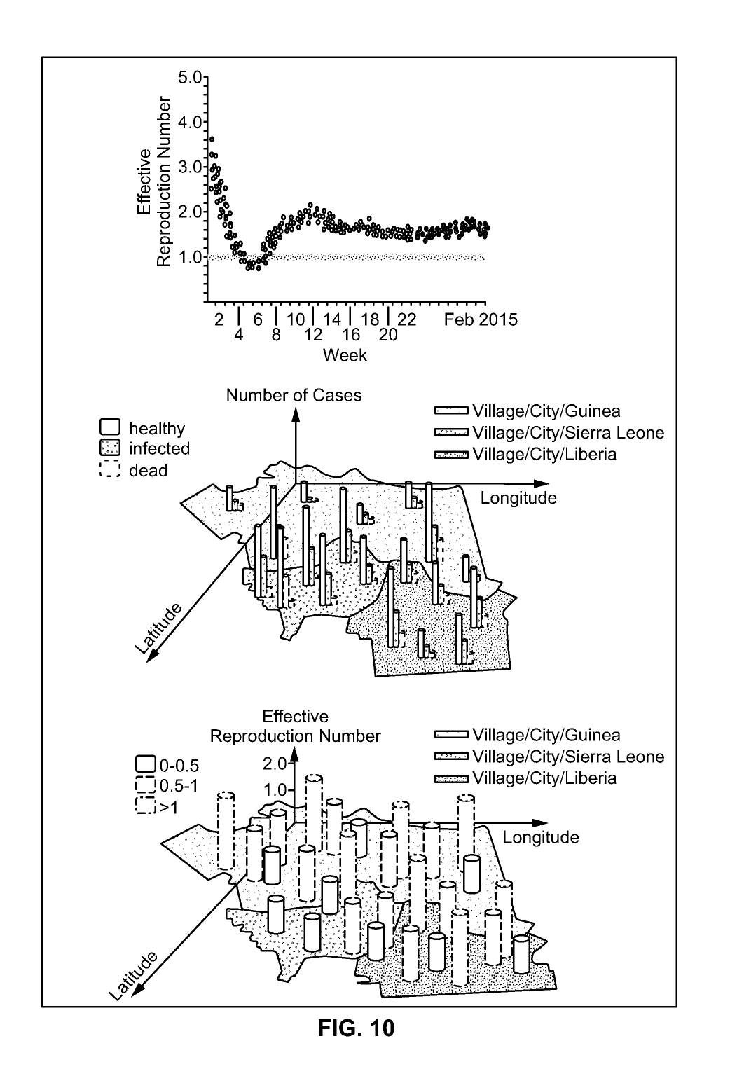

FIG. 10 demonstrates results. Provided is a set of effective reproduction numbers, using the statistical cellular automata, that indicates potential variations and changes introduced into propagation events, such as the Ebola epidemic. These numbers provide upper and lower bounds for the reproduction number (FIG. 10, top). Moreover, the framework also induces the potential bounds and changes for the upcoming timeframe. FIG. 10 (middle) shows how the numbers of healthy, infected and dead are changing from one location to another. FIG. 10 (bottom) displays how the effective reproduction numbers vary from one location to another.

The spatio-temporal propagation model of the present invention can be applied to the prediction or forecasting of a propagation event and/or spreading pattern at the microscopic level as well, i.e., intra-patient. For example, it may be used to forecast or predict Ebola growth patterns intra-patient. This enables the integration of microscopic and macroscopic propagation modalities for enhanced prediction of a propagation event and/or spreading pattern, such as disease propagation over time. The deployment of the embodiments of the present invention is not limited to Ebola outbreaks/epidemics. Other embodiments are applicable to other infectious diseases to understand the potential evolution, mutation, and growth pattern changes due to vaccinations at the microscopic level or due to countermeasures (e.g., road barriers or quarantine, etc.), and their impact at the macroscopic level.

In some embodiments, due to the inherent computational parallelism of the cellular automata Hopfield dynamic approach, high performance computing and cloud-computing can be employed to achieve real time monitoring and prediction of infectious diseases from microscopic to macroscopic levels, i.e., from intra-person to inter-person to inter-village/city to inter-region to inter-country, etc. As such, the approach is highly scalable, seamless, and continuous between the microscopic and macroscopic levels and within both, respectively.

In other aspects, embodiments of the present invention concern road mobility impact on vector borne diseases and Category A agents. Road mobility, the ability to transport human beings through land travel, has been identified as the key factor of several pandemics of infectious diseases in the last 500 years. However, little has been done to understand its impact on infectious disease transmission.

The last several years have witnessed a couple of successful predictions for vector borne diseases such as Malaria and Chikungunya virus (CHIKV), viral zoonosis like Rift Valley Fever, and bacterial disease spreading by contaminated water and food such as Cholera. All the above mentioned diseases exhibit close links to climate variability and seasonality, especially tending to occur episodically after elevated temperatures and increased rainfall. As such, a number of environmental variables may be integrated into the prediction models. For example, sea surface height (SSH), sea surface temperature (SST), ocean chlorophyllconcentration (OCC), El Niño/Southern Oscillation (ENSO), normalized difference vegetation index (NDVI), outgoing long-wave radiation (OLR), land surface temperature (LST) have demonstrated close correlations to the above mentioned disease outbreaks in Africa and South Asia. Using time-dependent climate and environmental variability, researchers have successfully predicted the incidence of Cholera in Zanzibar, East Africa by employing a multivariate autoregressive integrated moving average (ARIMA) model. The output of this predictive model was a monthly prediction of Cholera cases in one region of Unguja in Zanzibar. No geospatial distribution or concentration information was included in this case.

In fact, little has been done to provide dynamic, geospatial-temporal predictions for the risk of infection with virulence and transmissibility parameters. Not to mention that the existing prediction capability has only been validated for the above mentioned infectious diseases which have close links to climate and environmental variations.

Recent findings have provided proof and indications that land trade routes, troop or human movement through land roads have triggered outbreaks of several vector-borne diseases including Yellow Fever, Dengue, and Cholera. These outbreaks share a similar feature: all of them are caused by the large-scale movements of susceptible human beings into high risk zones (e.g., rural areas to cities through roads and highways) with little control measures.

Emerging infectious diseases, especially Category A (such as Ebola, Anthrax, smallpox, etc.), may not be highly correlated to the environmental variability, and yet, these diseases are of highly unexpected nature: they may originate from remote areas such as Africa or south China, or are an immediate consequence of a biological weapon (i.e., Anthrax). Most of these pathogens are rarely seen in developed countries such as the USA, but they pose a risk to national security as these diseases can be easily transmitted from one person to another, causing high mortality rates, and leading to public panic and social instability. The emerging infectious diseases call for advanced prediction capacity and capability to allow decision makers to take timely and special action for troop/personnel deployment (e.g., through road vs. ship vs. air transportation), to generate public health preparedness, to initiate control-and-response capabilities (e.g., to install treatment units ahead of time), and ultimately to prevent or at least limit disease outbreaks.

In an exemplary application of one embodiment of the present invention, Ebola was selected as a representative of a Category A disease to demonstrate and validate the embodiment. With over 13,500 reported cases and 70% fatality rate (a big increase from the previously estimated 50%), the 2014 Ebola outbreak in West Africa has become one of the deadliest occurrences since its first discovery in 1976. Running away patients, burial rituals (e.g., washing of the diseased prior to burial), notoriously poor villages, filthy and overcrowded slums in cities, and lack of effective control measures in the three Ebola outbreak countries Liberia, Sierra Leone, and Guinea are the leading causes of the rapid spread of the Ebola virus in the West Africa region. According to the World Health Organization (WHO), without drastic improvements in control measures, the number of deaths from the Ebola virus was expected to reach thousands per week. Since the first Ebola death on Oct. 1, 2014 in the USA, the Ebola outbreak has become a global epidemic.

In yet other aspects, the present invention involves accessing existing information systems, such as road maps combined with weather data that may include hourly, daily and historical data for local regions, as well as regional road conditions. In yet other embodiments, the present invention may access the Global Information Grid (GIG), Joint Effects Model (JEM), and/or Joint Warning and Reporting (JWARN) to support the necessary exchange of data and applications between the embodiments of the present invention and these information systems.

In other embodiments, the present invention considers, without limitation of generality, seven different road conditions that are affected by weather as: “dry”, “damp”, “rain moisture”, “wet”, “aquaplaning”, “fog”, “flooded”. A weather impact index (WI) is assigned to each road condition. For example, “flooded” can cause a road block. The WI for this condition is therefore “0”, i.e., no throughput as this road cannot be used for travel at this point in time. Table 1 summarizes the seven road conditions and the associated WI for each condition.

TABLE 1
Example road condition and weather impact indices

| | Weather Impact |
|---|---|
| Road Condition | Index (WI) |
| dry | 1.0 |
| damp | 0.9 |
| rain moisture | 0.6 |
| wet | 0.4 |
| aqua planning | 0.2 |
| fog | 0.1 |
| flooded | 0 |

In addition to weather impact, the road mobility is also affected by width and length of the road (which determines the throughput volume of, e.g., cars/vehicles). In general, long and narrow roads tend to have lower mobility than wider ones. An aspect ratio may be used to model the road basic property:

$$ar = \frac{L}{w} .$$

Here L represents road length and w denotes road width. Moreover, road mobility is also affected by its natural condition/quality, e.g., paved road vs. unpaved dirt road.

The Hopfield networks will continue to update the neural states in each village/city (FIG. 2). On the other hand, the 2D Cellular Automata framework will account for the inter-village/city transfer of diseases. Here, interactions of all villages/cities with all other villages/cities in a region or country may make no sense. Rather, interactions based on nearest neighbors (weighted by for example Euclidian distance and/or street conditions, such as dirt road vs. paved multi-lane highway) make much more sense, and this is precisely what 2D Cellular Automata are good at simulating (FIG. 2). The throughput rate is used to indicate the interaction strength between any two locations (or nodes) as shown in FIG. 2. In one instantiation, the throughput rate through roads leading from A to B may be defined as T_{AB} which can be estimated as:

$${T}_{AB} ( t ) = [ {\sum }_{i = 1}^{n} \frac{{W}_{i} ( t )}{{L}_{i} ( t )} \cdot {WI}_{i} ( t ) ] \cdot {P}_{AB} ( t ) \qquad ( 7 )$$

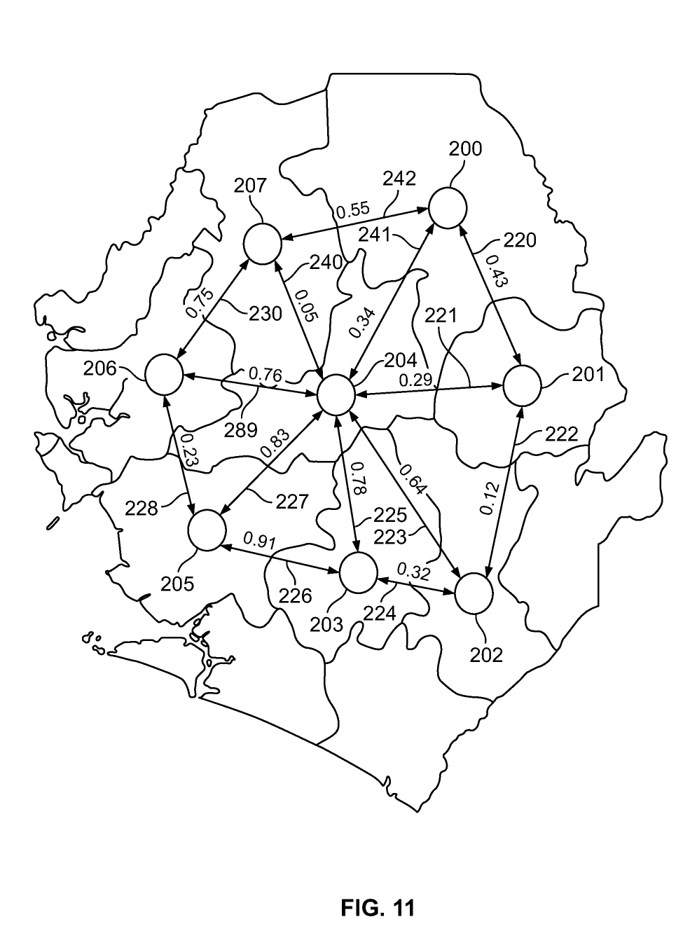

Here P_{AB} is the average number of people attempting to go from A to B, e.g., per day. Lᵢ, Wᵢ are road i length and width, respectively. And WIᵢ is the weather index for road (refer to Table 1 above). Note that all the above parameters are time-variant. The proposed model is applicable to real time updates where P_{AB} represents the average number of people going from A to B in real time (e.g., per hour). FIG. 11 shows the interaction strengths of the macroscopic interactions using the throughput rate computation in (7). Here (7) is used to explicitly estimate the strength of interactions among different locations 200-207 through road connections 220-242.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. A method to geospatially and temporally predict a propagation event comprising the steps of:
(a) for a plurality of predetermined locations, geospatially modeling the connections between each location;
(b) for each predetermined location, temporally modeling the connections within each predetermined location; and
(c) pairing said geospatially modeling with said temporal modeling to generate a prediction of the spread of the propagation event.

2. The method of claim 1 further comprising the step of pairing 2D Cellular Automaton with Hopfield Attractor Network Dynamics.

3. The method of claim 1 further comprising the step of pairing said 2D Cellular Automata for inter-village and/or city interactions on a macroscopic scale, with said dynamics of Hopfield Attractor Artificial Neural Networks for intra-village and/or city interactions on a microscopic scale.

4. The method of claim 1 further comprising the step of generating output that includes a colored map with supporting displays such as pie-charts, curves, diagrams and/or text messages at different levels of granularity to provide detailed warnings and alerts with predicted number of said growth spread.

5. The method of claim 1 wherein said predetermined locations are zip-codes.

6. The method of claim 3 further comprising Hopfield attractor networks with N neurons that are connected to each other via N(N−1)/2 couplings or interaction pathways for non-local interactions.

7. The method of claim 3 further comprising Hopfield attractor networks wherein the neural coupling strength is inversely proportional to the number of inhabitants of a predetermined location expressed as proximity factors that may reflect gathering behaviors specific to said predetermined location.

8. The method claim 2 wherein said 2D Cellular Automaton interactions have varying weights.

9. The method of claim 8 wherein said varying weights of said interactions are based on conditions between the nearest neighbors or road mobility models.

10. The method of claim 9 wherein said varying weights of said interactions are based on distance and/or street conditions.

11. The method of claim 1 further comprising the step of using a Stochastic Optimization Framework (SOF) that samples model-intrinsic parameter space by repeatedly running the respective model forward and by comparing the outcomes against the desired outcome, which results in a fitness measure.

12. The method of claim 11 further comprising the step of extrapolating time-wise the behavior of the SOF-obtained cellular automaton Hopfield attractor network that is specific to both a region and a particular propagation event to yield probability maps of growth spread and spread prediction for a particular region.

13. The method of claim 11 further comprising the step of using polynomial chaos series to predict the number of incidences for a future time period.

14. The method of claim 1 further comprising the step of providing a map of a predetermined region.

15. The method of claim 14 further comprising the step of providing a map of a predetermined region wherein at each level, different operations are shown.

16. The method of claim 15 further comprising the step of providing a map of a predetermined region wherein basic operations used include “Zoom In”, “Zoom Out”, “New Node” (for cities/villages/regions), and parameter inputs from historical data through file upload.

17. The method of claim 14 further comprising the step of providing a map of a predetermined region wherein there is “weight” for the edges and “concentration” for the changes of node values to reflect condition changes.

18. The method of claim 14 further comprising the step of providing a map of a predetermined region wherein a user is allowed to focus on one or more locations of interest by selecting a predetermined area or region which are displayed on one or more colored maps for outbreak predictions or forecasts in temporal and geospatial forms.

19. The method and system of claim 17 characterized in that it further comprises a step of providing a map of a predetermined region wherein the edges connecting nodes represent roads and different thickness of edges denote variations in the road throughputs or road mobility models.

20. The method of claim 19 further comprising the step of providing a map of a predetermined region wherein the thicker the edge, the higher throughput of the road.
